(19) United States
(12) Patent Application Publication
(10) Pub. No.: US 2008/0101837 A1
(43) Pub. Date: May 1, 2008

(54) PRINTING MEDIUM FEEDING APPARATUS AND IMAGE FORMING APPARATUS USING THE SAME

(75) Inventor: Hyun-ki CHO, Hanam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/854,873

(22) Filed: Sep. 13, 2007

(30) Foreign Application Priority Data
Oct. 30, 2006 (KR) 2006-105866

(51) Int. Cl. G03G 15/00

(52) U.S. Cl. 399/393

(57) ABSTRACT

A feeding apparatus that feeds a printable medium from a cassette having a knock-up plate in which the printable medium is loaded and an elastic member that elastically biases the knock-up plate. The apparatus includes a pick-up roller that draws out one printable medium loaded in the knock-up plate while rotating once; a cam member that is installed in the pick-up roller and operates in interlocking with circulation driving of the pick-up roller; a lever that separates the knock-up plate from the pick-up roller by interacting with the cam member at the time of transferring the printable medium drawn out by the pick-up roller and; and a transfer roller that transfers the printable medium drawn out by the pick-up roller.

### CROSS-REFERENCE TO RELATED APPLICATIONS

This application claims all benefits accruing under 35 U.S.C. §119 from Korean Patent Application No. 2006-105866, filed in the Korean Intellectual Property Office on Oct. 30, 2006, the disclosure of which is incorporated herein by reference.

### BACKGROUND OF THE INVENTION

1. Field of the Invention

Aspects of the present invention relate to a printable medium feeding apparatus using a friction pad separation method and an image forming apparatus using the same and, more particularly, to a printable medium feeding apparatus having a structure which is capable of reducing friction noise occurring between a feeding printable medium and a printable medium loaded in a cassette in the process of printing, and an image forming apparatus using the same.

2. Related Art

A printable medium feeding apparatus that is generally used in an image forming apparatus, such as a printer, a copying machine, a facsimile machine, or a multi-function device, picks up printable media loaded in a cassette sheet by sheet and feeds the printable medium to the image forming apparatus.

FIG. 1 is a schematic side view showing a conventional printable medium feeding apparatus using a friction pad separation method. The conventional printable medium feeding apparatus includes a pick-up roller 20 that draws printable media 1 out of a cassette 10 in which the printable media 1 are loaded, a multi-feeding prevention member 30 that prevents double feeding of the printable media 1, and a transfer roller 41 that transfers a drawn printable medium 1a.

The cassette 10 includes a knock-up plate 11 in which the printable media 1 are loaded, an elastic member 15 that elastically biases the knock-up plate 11 to the pick-up roller 20, and a friction member 13 arranged in an upper side of the knock-up plate 11. The printable media 1 loaded in the knock-up plate 11 are transferred sheet by sheet by the pick-up roller 20. The friction member 13, which is formed at a position facing the pick-up roller 20 over the knock-up plate 11, prevents multi-feeding of the printable media 1 by providing a printable medium contacting the friction member 13 with a friction force stronger than the friction force between the sheets of printable media 1.

The pick-up roller 20 includes an idle part 21 and a pick-up part 23 that picks up the printable media 1. The pick-up roller 20 feeds one sheet of printable medium per rotation. While the pick-up part 23 rotates in contact with the uppermost one printable medium 1 a loaded in the knock-up plate 11, the printable medium 1a is transferred to the transfer roller 41. Subsequently, the idle part 21 faces the transferring printable medium 1a and rotates until the transfer is complete. The multi-feeding prevention member 30 includes a friction pad 31 that faces the pick-up roller 20 and prevents multi-feeding of the printable medium 1 a transferred by the pick-up roller 20.

In the conventional feeding apparatus constructed as above, the idle part 21 presses the printable media on the knock-up plate 11 while the printable medium 1a that was picked up by the pick-up part 23 is transferred by the transfer roller 41. Accordingly, a normal force of a measurable level is generated between the pick-up roller 20 and the printable media 1, and accordingly, friction noise is generated by the friction between the transferring printable medium 1a and a printable medium 1b located immediately under the printable medium 1a.

FIG. 2 is a graph showing a printable medium friction noise distribution in an image forming apparatus employing the printable medium feeding apparatus constructed as above. It can be seen from FIG. 2 that driving noise of 50 dB is generated while driving the image forming apparatus, whereas noise of 52 dB, which represents an addition of printable medium friction noise of about 2 dB to the driving noise of 50 dB, is generated in a printing section of operation.

Since the friction noise between the printable media deteriorates silence property of the image forming apparatus, there is a need to reduce the friction noise.

### SUMMARY OF THE INVENTION

Aspects of the present invention provide a printable medium feeding apparatus which is capable of reducing friction noise between printable media by removing a normal force that is applied to a knock-up plate in an idle section of operation of a pick-up roller.

According to an aspect of the present invention a feeding apparatus is provided that feeds a printable medium from a cassette having a knock-up plate in which the printable medium is loaded and an elastic member that elastically biases the knock-up plate. The printable medium feeding apparatus comprises a pick-up roller to draw out one printable medium loaded in the knock-up plate; a cam member installed in the pick-up roller to operate in interlocking with the rotation of the pick-up roller; a transfer roller to transfer the printable medium drawn out by the pick-up roller for image formation; and a lever to separate the knock-up plate from the pick-up roller by interacting with the cam member while the transfer roller transfers the printable medium drawn out by the pick-up roller.

According to another aspect of the invention, the lever comprises a hinge part; and an arm part having one side arranged to contact the cam member and to rotate around the hinge part, and another side arranged to press one side of the knock-up plate such that the knock-up plate is separated from the pick-up roller.

According to another aspect of the invention, the cam member is disposed so as to contact the arm part and to rotatably press the lever when the printable medium drawn out by the pick-up roller is transferred by the transfer roller.

According to another aspect of the invention, the feeding apparatus further comprises a multi-feeding prevention member disposed so as to face the pick-up roller and having a friction pad to prevent multi-feeding of the printable medium by a friction force.

According to another aspect of the present invention a feeding apparatus is provided to feed a printable medium from a cassette having a knock-up plate in which the printable medium is loaded and an elastic member that elastically biases the knock-up plate. The printable medium feeding apparatus comprises a pick-up roller to draws out one printable medium loaded in the knock-up plate; a cam member installed in the pick-up roller to operate in interlocking with the rotation of the pick-up roller; a transfer roller to transfer the printable medium drawn out by the pick-up roller for image formation; and a separating part formed on the knock-up plate so as to selectively contact the cam member to separate the knock-up plate from the pick-up roller by interacting with the cam member while the transfer roller transfers the printable medium drawn out by the pick-up roller.

According to another aspect of the present invention, the cam member is disposed to contact the separating part and to press the knock-up plate when the printable medium drawn out by the pick-up roller is transferred by the transfer roller.

According to another aspect of the invention, the feeding apparatus further comprises a multi-feeding prevention member disposed to face the pick-up roller and having a friction pad to prevent multi-feeding of the printable medium by a friction force.

According to another aspect of the present invention an image forming apparatus is provided. The image forming apparatus comprises a cassette to supply a printable medium and having a knock-up plate in which the printable medium is loaded and an elastic member that elastically biases the knock-up plate; a printable medium feeding apparatus according to any of the above aspects of the present invention; a developing unit to develops supplied toner so as to form an image; a light scanning unit to form an electrostatic latent image by scanning the developing unit with a light beam; a transfer unit to transfer the image formed in the developing unit onto the printable medium fed by the printable medium feeding apparatus; and a fixation unit to fixes the image transferred onto the printable medium.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a schematic side view showing a conventional printable medium feeding apparatus using a friction pad separation method;

FIG. 2 is a graph showing a printable medium friction noise distribution in an image forming apparatus employing the conventional printable medium feeding apparatus of FIG. 1;

FIG. 3 is a schematic side view showing a printable medium feeding apparatus according to an example embodiment of the present invention;

FIGS. 4A to 4C are views illustrating an operation of the printable medium feeding apparatus of FIG. 3;

FIG. 5 is a schematic side view showing a printable medium feeding apparatus according to another example embodiment of the present invention;

FIGS. 6A to 6C are views illustrating an operation of the printable medium feeding apparatus of FIG. 5; and

FIG. 7 is a schematic sectional view of an image forming apparatus employing a printable medium feeding apparatus according to an example embodiment of the present invention.

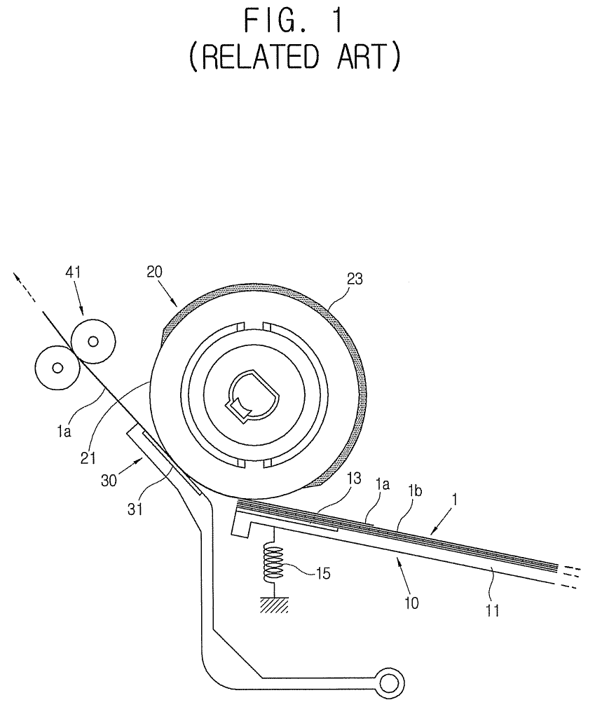

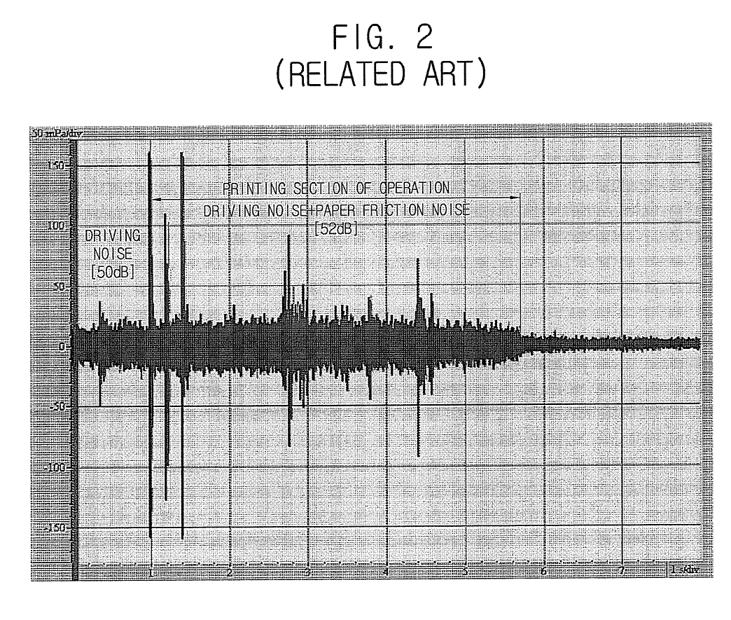

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

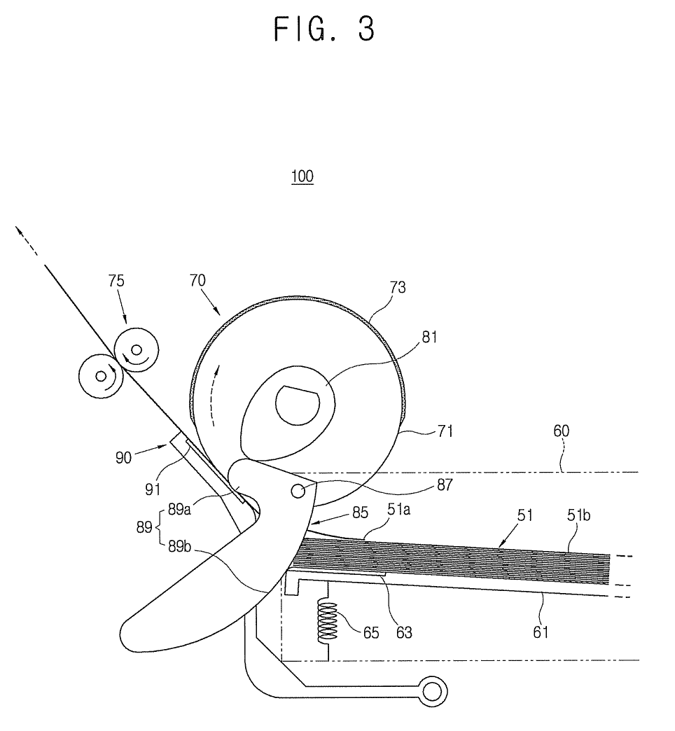

FIG. 3 is a schematic side view showing a printable medium feeding apparatus 100 according to an example embodiment of the present invention. The printable medium feeding apparatus 100 comprises a pick-up roller 70 that draws printable media 51 out of a cassette 60 in which the printable media 51 are loaded, a cam member 81 and a lever 85 that interlocks with the pick-up roller 70, and a transfer roller 75 that transfers the drawn printable media 51.

The cassette 60 comprises a knock-up plate 61 in which the printable media 51 are loaded, and an elastic member 65 that elastically biases the knock-up plate 61 to the pick-up roller 70. The cassette 60 may further comprise a friction member 63 disposed in an upper side of the knock-up plate 61. The friction member 63, which is formed at a position facing the pick-up roller 70 over the knock-up plate 61, prevents multi-feeding of the printable media 51 by providing a printable medium contacting the friction member 63 with a friction force stronger than a friction force between the sheets of printable media 51.

The pick-up roller 70 feeds one sheet of printable medium loaded in the knock-up plate 61 per rotation. The pick-up roller 70 comprises an idle part 71 and a pick-up part 73 that picks up the printable media 51. The printable medium 51a is transferred to the transfer roller 75 as the pick-up part 73 rotates in contact with the uppermost one printable medium 51a loaded in the knock-up plate 61. Subsequently, the idle part 71 faces the transferring printable medium 51a and rotates until the transfer is completed.

The cam member 81 is fixed to the pick-up roller 70 and operates in interlocking with the rotation of the pick-up roller 70. The cam member 81 is disposed so as to press the lever 85 when the printable medium 51a drawn out of the pick-up roller 70 is transferred in gear with the transfer roller 75 for image formation.

The lever 85 separates the knock-up plate 61 from the pick-up roller 70 by interacting with the cam member 81 at the time of transferring the printable medium 51a drawn out of the pick-up roller 70. The lever 85 comprises a hinge part 87 and an arm part 89 that rotates around the hinge part 87. The lever 85 may be installed in a housing (not shown) of the image forming apparatus in which the printable medium feeding apparatus is set in such a manner that the lever 85 can rotate around the hinge part 87. Alternatively, the lever 85 may be rotatably installed in the cassette 60 and not in the housing.

The arm part 89 comprises a first arm part 89a that selectively contacts the cam member 81 and a second arm part 89b that contacts one side of the knock-up plate 61. The first arm part 89a contacts the cam member 81 when the pick-up roller 70 is in an idle operation and rotates the second arm part 89b around the hinge part 87 by a force applied through the cam member 81. The second arm part 89b applies a force to the knock-up plate 61 such that the knock-up plate 61 is separated from the pick-up roller 70. During the idle section of operation, that is, when the pick-up roller 70 stops and the transfer roller 75 transfers the printable medium 51a, the knock-up plate 61 is separated from the pick-up roller 70 by interaction of the cam member 81 and the lever 85.

The printable medium feeding apparatus 100 may further comprise a multi-feeding prevention member 90 disposed to face the pick-up roller 70. The multi-feeding prevention member 90 has a friction pad 91 that prevents multi-feeding of the printable media 51 by a friction force. The friction pad 91 provides friction resistance to the back side of the printable medium 51a that is transferred by the pick-up roller 70 and the transfer roller 75 such that only one sheet of printable media 51 is transferred. Even if two or more sheets of printable media 51 are fed at once by the pick-up roller 70, the friction pad 91 prevents other printable media, such as printable medium 51b, from being transferred.

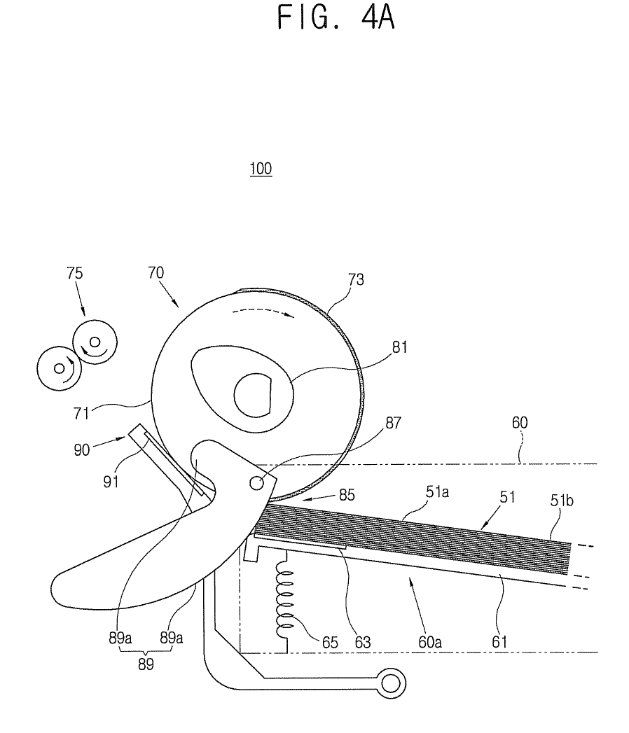

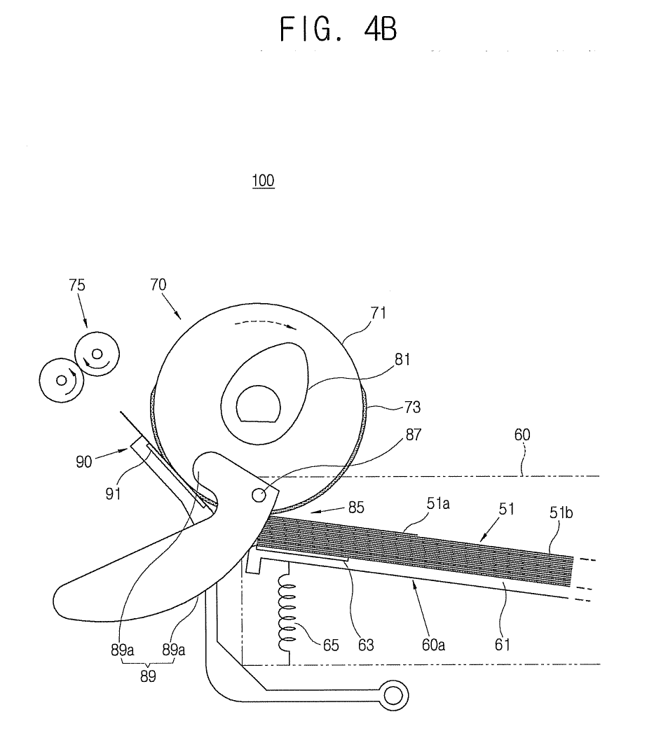

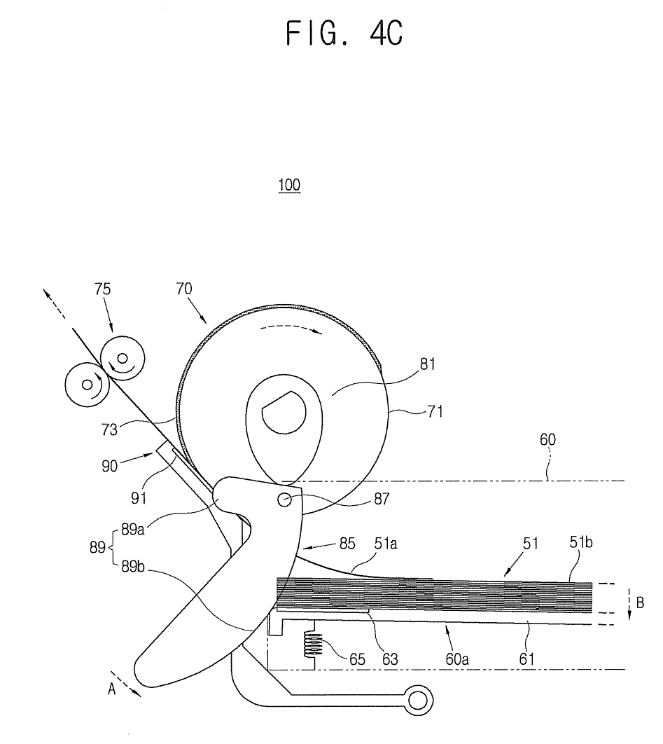

An operation of the printable medium feeding apparatus 100 will be described in detail with reference to FIGS. 4A to 4C. FIGS. 4A and 4B show a state of rotation of the pick-up roller 70 and the cam member 81 during a pick-up section of operation. Referring to FIG. 4A, since the cam member 81 is not in contact with the lever 85 and the lever 85 is freely rotatable, the knock-up plate 61 is raised by an elastic force of the elastic member 65. Accordingly, the printable medium 51a placed on the uppermost portion of the knock-up plate 61 contacts a leading end of the pick-up part 73.

Subsequently, as the pick-up roller 70 rotates continuously, the printable medium 51a placed on the uppermost portion of the knock-up plate 61 is transferred to the transfer roller 75. As shown in FIG. 4B, the cam member 81 remains separate from the lever 85.

FIG. 4C shows a state of rotation of the pick-up roller 70 and the cam member 81 during the idle section of operation. The cam member 81 contacts the first arm part 89a of the lever 85. The arm part 89 rotates in an arrow A direction around the rotation part 87, and the second arm part 89b presses against the knock-up plate 61. The knock-up plate 61 moves in an arrow B direction such that the knock-up plate 61 is separated from the pick-up roller 70. As such, a separation state is maintained up to the state shown in FIG. 3, the friction force between the printable medium 51a that is transferred from the uppermost portion of the knock-up plate 61 and the printable medium 51b placed immediately under the printable medium 51a is reduced, and noise due to the friction force during the idle section of operation can be reduced.

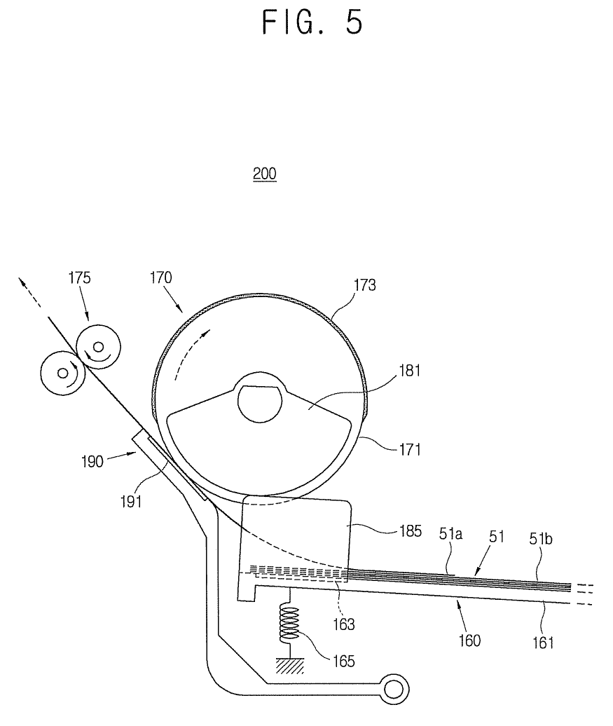

FIG. 5 is a schematic side view showing a printable medium feeding apparatus 200 according to another example embodiment of the present invention. The printable medium feeding apparatus 200 comprises a pick-up roller 170 that draws printable media 51 out of a cassette 160 in which the printable media 51 are loaded, a cam member 181 that interlocks with the pick-up roller 170, a separating part 185 that is formed on the cassette 160 and selectively contacts the cam member 181, and a transfer roller 175 that transfers the drawn printable media 51.

The cassette 160 comprises a knock-up plate 161 in which the printable media 51 are loaded, and an elastic member 165 that elastically biases the knock-up plate 161 toward the pick-up roller 170. The cassette 160 may further comprise a friction member 163 disposed in an upper side of the knock-up plate 161. The friction member 163, which is disposed at a position facing the pick-up roller 170 over the knock-up plate 161, prevents multi-feeding of the printable media 51 by providing a printable medium 51a contacting the friction member 163 with a friction force stronger than a friction force between the sheets of printable media 51.

The pick-up roller 170 feeds one sheet of printable medium loaded in the knock-up plate 161 while rotating once. The pick-up roller 170 comprises an idle part 171 and a pick-up part 173 that picks up the printable media 51. The pick-up roller 170 has the same structure and operation as the pick-up roller 70 shown in FIG. 3, and therefore, detailed explanation thereof is omitted for the sake of avoiding complexity of description.

The cam member 181 is coupled to the pick-up roller 170, and operates in interlocking with circulation driving of the pick-up roller 170. As the pick-up roller 170 rotates, the cam member 181 alternately presses against and releases the separating part 185. When the printable medium 51 drawn out of the pick-up roller 170 is transferred by the transfer roller 175, the cam member 181 is disposed to press against the separating part 185.

The separating part 185 is formed to protrude from, or is coupled to, the knock-up plate 161 and selectively contacts the cam member 181. The separating part 185 separates the knock-up plate 161 and the printable medium 51 loaded on the knock-up plate 161 from the pick-up roller 170 by interacting with the cam member 181 when the printable medium 51 drawn out of the pick-up roller 170 is being transferred.

As the pick-up roller 170 contacts the cam member 181 during an idle operation, the separating part 185 causes the knock-up plate 161 to move in a direction in which the knock-up plate 161 is separated from the pick-up roller 170. As described above, during the idle section of operation, that is, an operation section in which the pick-up roller 170 stops and the transfer roller 175 transfers the printable medium 51a to the image forming apparatus (not shown), the knock-up plate 161 is separated from the pick-up roller 170 by interaction of the cam member 181 and the separating part 185.

The printable medium feeding apparatus 200 may further comprise a multi-feeding prevention member 190 disposed to face the pick-up roller 170 and having a friction pad 191. The multi-feeding prevention member 190 has the same structure and operation as the multi-feeding prevention member 90 shown in FIG. 3, and therefore, detailed explanation thereof is omitted for the sake of avoiding complexity of description.

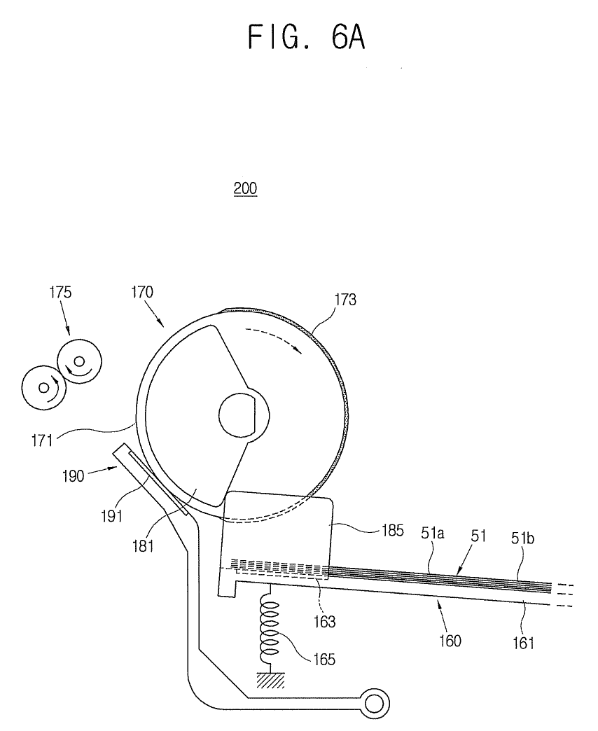

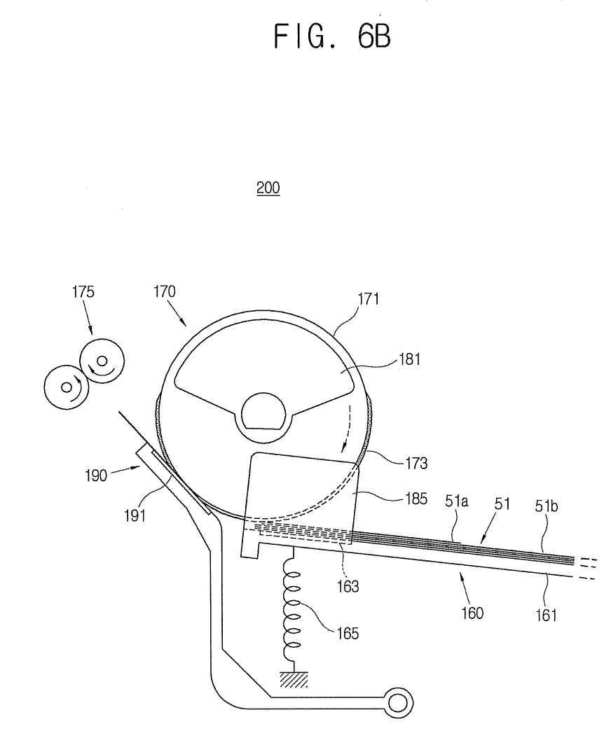

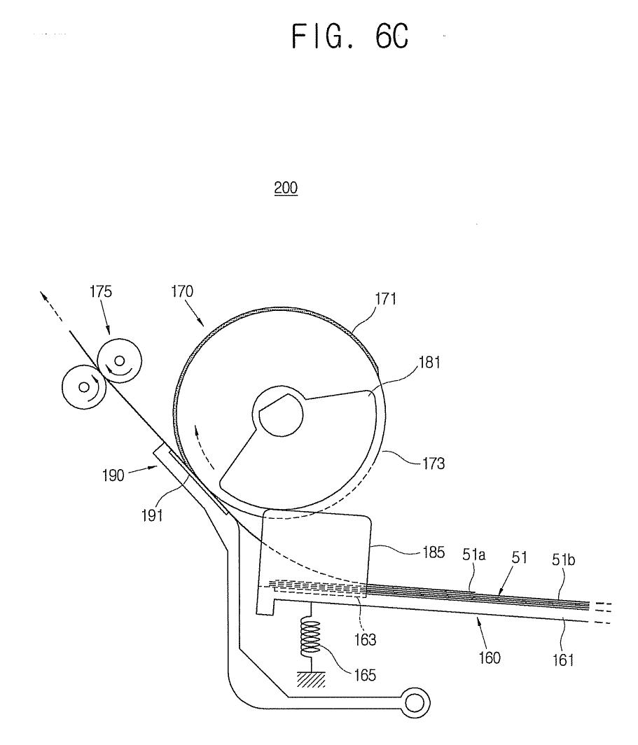

An operation of the printable medium feeding apparatus 200 will be described in detail with reference to FIGS. 6A to 6C. FIGS. 6A and 6B show a state of rotation of the pick-up roller 170 and the cam member 181 in a pick-up section of operation. Referring to FIG. 6A, since the cam member 181 is not in contact with the separating part 185, the knock-up plate 161 is raised by an elastic force of the elastic member 165. Accordingly, the printable medium 51a placed on the uppermost portion of the knock-up plate 161 contacts a leading end of the pick-up part 173. Subsequently, as the pick-up roller 170 continues to rotate, the printable medium 51a placed on the uppermost portion of the knock-up plate 161 is transferred to the transfer roller 175. As shown in FIG. 6B, the cam member 181 remains separated from the separating part 185.

FIG. 6C shows a state of rotation of the pick-up roller 170 and the cam member 181 in the idle section of operation. The cam member 181 contacts the top of the separating part 185, and accordingly, the knock-up member 161 is lowered along with the separated part 185. Accordingly, the knock-up plate 161 is separated from the pick-up roller 170. As such, a separation state is maintained up to the rotation state of the cam member 181 as shown in FIG. 5, the friction force between the printable medium 51a that is transferred from the uppermost portion of the knock-up plate 161 and the printable medium 51b placed immediately under the printable medium 51a is reduced, and noise due to the friction force in the idle section of operation can be reduced.

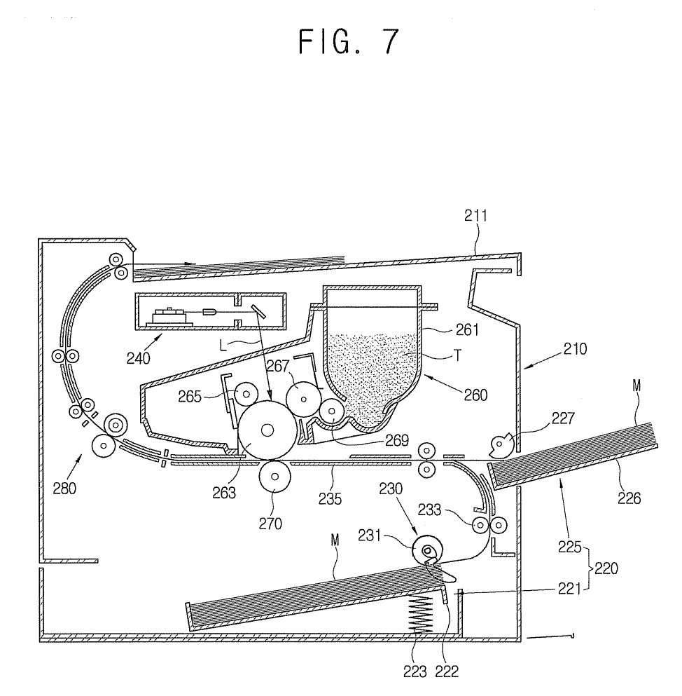

FIG. 7 is a schematic sectional view showing an image forming apparatus according to an example embodiment of the present invention. The image forming apparatus comprises a cabinet 210, a printable medium feeding unit 220, a developing unit 260, a light scanning unit 240 that forms an electrostatic latent image, a transfer unit 270 that transfers an image formed in the developing unit 260 onto a printable medium M, and a fixation unit 280 that fixes the image transferred onto the printable medium M.

The cabinet 210 forms a contour of the image forming apparatus. A discharge unit 211 in which a discharged printable medium M is loaded is provided in the outside of the cabinet 210. The feeding unit 220, which feeds the developing unit 260 with the printable medium M, comprises a first feeding part 221 that is used to automatically feed the printable medium M and a second feeding part 225 that is used to manually feed the printable medium M.

The first feeding part 221 comprises a first cassette that is detachably installed within the cabinet 210 and a printable medium feeding unit 230. The first cassette comprises a first knock-up plate 222 in which the printable medium M is loaded and an elastic member 223 that elastically biases the first knock-up plate 222. The printable medium feeding unit 230 feeds the printable medium M loaded in the first knock-up plate 221 to the developing unit 260 and has a structure as shown in FIGS. 3 and 5 to reduce the friction noise between printable media M at the time of feeding the printable media M. The printable medium M is picked up from a first pickup roller 231 of the printable medium feeding unit 230, and the first knock-up plate 221 is separated from the first pick-up roller 231 during an idle section of operation in which the printable medium M picked up through the first transfer roller 233 is transferred. When the printable medium M is picked up, the printable medium M loaded in the first knock-up plate 221 contacts the first pick-up roller 231 such that a regular pickup operation is performed. The printable medium feeding apparatus 230 may have substantially the same structure as the printable medium feeding apparatuses 100 and 200 described with reference to FIGS. 3 to 6C, and therefore, detailed explanation thereof is omitted for the sake of avoiding complexity of description.

The second feeding part 225 is provided in the outside of the cabinet 210 and comprises a second cassette 226 and a second pick-up roller 227. The second feeding part 225 provides a transfer path 235 with the printable medium M by rotation of the second pick-up roller 227. The second feeding part 225 may have a configuration including the printable medium feeding unit having a configuration as shown in FIGS. 3 and 5 like the first feeding part 221, without being limited to the configuration as shown in FIG. 7.

The developing unit 260 has a toner container 261 in which a color toner T is accommodated, and an image forming part that contributes to forming an image with the toner T fed from the toner container 261. The image forming part comprises a photosensitive medium 263 that is responsive to a beam L scanned from the light scanning unit 240, a charger 265 that charges the photosensitive medium 263 to have a predetermined electric potential, a developing roller 267 that is disposed to face the photosensitive medium 262 and develops toner in a region in which an electrostatic latent image of the photosensitive medium 263 is formed, and a feeding roller 269 that feeds the developing roller 267 with the toner T.

The light scanning unit 240 scans the photosensitive medium 263 with light such that the electrostatic latent image is formed on the photosensitive medium 263. The transfer unit 270 is arranged so as to face the photosensitive medium 263 with the printable media M interposed therebetween, and transfers a toner image, which is formed on the photosensitive medium 263, onto the fed printable medium M. The image transferred onto the printable medium M by the transfer unit 270 is fixed by the fixation unit 280. Subsequently, the printable medium M onto which the toner image is transferred is discharged to the discharge unit 211 through the transfer path 235.

As apparent from the above description, aspects of the present invention provide a printable medium feeding apparatus which is capable of removing a normal force that is applied to the knock-up plate during the idle section of operation of the pick-up roller by interaction of the cam member and the lever or by interaction of the cam member and the separating part. Thus, an image forming apparatus that adopts the printable medium feeding apparatus has an advantage of reduction of friction noise between printable media.

In addition, the image forming apparatus employing the printable medium feeding apparatus according to aspects of the present invention has an advantage of improvement of silence property by reducing the friction noise arising between sheets of printable media.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the lever 85, shown in FIG. 3, may be seen as an example of a separation part that selectively contacts the cam member while the printable medium is being transferred to the image forming apparatus and that separates the knock-up plate from the pick-roller while the printable medium is being transferred to the image forming apparatus. Accordingly, it is intended, therefore, that the present invention not be limited to the various example embodiments disclosed, but that the present invention includes all embodiments falling within the scope of the appended claims.

What is claimed is:

1. A feeding apparatus to feed a printable medium from a cassette having a knock-up plate in which the printable medium is loaded and an elastic member that elastically biases the knock-up plate, comprising:
a pick-up roller to draw out one printable medium loaded in the knock-up plate;
a cam member installed in the pick-up roller to operate in interlocking with the rotation of the pick-up roller;
a transfer roller to transfer the printable medium drawn out by the pick-up roller for image formation; and
a lever to separate the knock-up plate from the pick-up roller by interacting with the cam member while the transfer roller transfers the printable medium drawn out by the pick-up roller.

2. The feeding apparatus according to claim 1, wherein the lever comprises:
a hinge part; and
an arm part having one side arranged to contact the cam member and to rotate around the hinge part, and another side arranged to press one side of the knock-up plate such that the knock-up plate is separated from the pick-up roller.

3. The feeding apparatus according to claim 2, wherein the cam member is disposed so as to contact the arm part and to rotatably press the lever when the printable medium drawn out by the pick-up roller is transferred by the transfer roller.

4. The feeding apparatus according to claim 1, further comprising:
a multi-feeding prevention member disposed so as to face the pick-up roller and having a friction pad to prevent multi-feeding of the printable medium by a friction force.

5. A feeding apparatus to feed a printable medium from a cassette having a knock-up plate in which the printable medium is loaded and an elastic member that elastically biases the knock-up plate, the apparatus comprising:
a pick-up roller to draw out one printable medium loaded in the knock-up plate;
a cam member installed in the pick-up roller to operate in interlocking with rotation of the pick-up roller;
a transfer roller to transfer the printable medium drawn out by the pick-up roller for image formation; and
a separating part formed on the knock-up plate so as to selectively contact the cam member and to separate the knock-up plate from the pick-up roller by interacting with the cam member while the transfer roller transfers the printable medium drawn out by the pick-up roller.

6. The feeding apparatus according to claim 5, wherein the cam member is disposed to contact the separating part and to press the knock-up plate when the printable medium drawn out by the pick-up roller is transferred by the transfer roller.

7. The feeding apparatus according to claim 5, further comprising:
a multi-feeding prevention member disposed to face the pick-up roller and having a friction pad to prevent multi-feeding of the printable medium by a friction force.

8. An image forming apparatus comprising:
a cassette to supply a printable medium and having a knock-up plate in which the printable medium is loaded and an elastic member that elastically biases the knock-up plate;
a feeding apparatus according to claim 1;
a developing unit to develop supplied toner so as to form an image;
a light scanning unit to form an electrostatic latent image by scanning the developing unit with a light beam;
a transfer unit to transfer the image formed in the developing unit onto the printable medium fed by the printable medium feeding apparatus; and
a fixation unit to fix the image transferred onto the printable medium.

9. The image forming apparatus according to claim 8, wherein the lever comprises:
a hinge part; and
an arm part having one side that contacts the cam member and rotates around the hinge part, and another side that presses one side of the knock-up plate such that the knock-up plate is separated from the pick-up roller.

10. The image forming apparatus according to claim 9, wherein the cam member is disposed so as to contact the arm part and to rotatably press the lever when the printable medium drawn out by the pick-up roller is transferred by the transfer roller to the transfer unit.

11. The image forming apparatus according to claim 8, further comprising:
a multi-feeding prevention member disposed so as to face the pick-up roller and having a friction pad to prevent multi-feeding of the printable medium by a friction force.

12. An image forming apparatus comprising:
a cassette to supply a printable medium and having a knock-up plate in which the printable medium is loaded and an elastic member that elastically biases the knock-up plate;
a feeding apparatus according to claim 5;
a developing unit to develop supplied toner to form an image;
a light scanning unit to form an electrostatic latent image by scanning the developing unit with a beam;
a transfer unit to transfer the image formed in the developing unit onto the printable medium fed by the printable medium feeding apparatus; and
a fixation unit to fix the image transferred on the printable medium.

13. The image forming apparatus according to claim 12, wherein the cam member is disposed to contact the separating part and to press the knock-up plate when the printable medium drawn out by the pick-up roller is transferred by the transfer roller to the transfer unit.

14. The image forming apparatus according to claim 12, further comprising:
a multi-feeding prevention member disposed to face the pick-up roller and having a friction pad to prevent multi-feeding of the printable medium by a friction force.

15. A feeding apparatus comprising:
a pick-up roller to pick up a printable medium loaded on a knock-up plate so as to transfer the printable medium for image formation;
a cam member installed on the pick-roller so as to rotate with the rotation of the pick-up roller; and
a separating part arranged so as to selectively contact the cam member and to separate the knock-up plate from the pick-roller while the printable medium is being transferred to the image forming apparatus.

16. The feeding apparatus of claim 15, wherein the separating part comprises a lever having a hinge part and an arm part with one side arranged so as to contact the cam member and to rotate around the hinge part and another side arranged so as to press against the knock-up plate such that the knock-up plate is separated from the pick-up roller while the printable medium is transferred to the image forming apparatus.

17. The feeding apparatus of claim 15, wherein the separating part is coupled to the knock-up plate to separate the knock-up plate from the pick-up roller by interacting with the cam member while the printable medium is transferred to the image forming apparatus.

18. The feeding apparatus of claim 15, further comprising:
a transfer roller to transfer the printable medium picked up by the pick-up roller to the image forming apparatus.

19. The feeding apparatus of claim 15, further comprising:
a multi-feeding prevention member disposed so as to face the pick-up roller and having a friction pad to prevent multi-feeding of the printable medium by a friction force.

20. A method of transferring a printable medium comprising:
supplying the printable medium in a cassette having a knock-up plate; and
driving a pick-up unit having a pick-up roller to transfer the printable medium, while the movement of the cassette is operatively associated with the rotation of the pick-up unit;
wherein the knock-up plate and the pick-up roller are separated by a lever while the printable medium is not being transferred.
